(19) United States
(12) Patent Application Publication
(10) Pub. No.: US 2024/0250344 A1
(43) Pub. Date: Jul. 25, 2024

(54) BATTERY THERMAL MITIGATION USING COOLANT

(71) Applicant: FORD GLOBAL TECHNOLOGIES, LLC, Dearborn, MI (US)

(72) Inventors: George Albert Garfinkel, Westland, MI (US); Suman Mishra, Canton, MI (US)

(21) Appl. No.: 18/157,119

(22) Filed: Jan. 20, 2023

(51) Int. Cl. H01M 10/6569; H01M 10/613; H01M 10/6556; H01M 10/6568

(52) U.S. Cl. CPC H01M 10/6569; H01M 10/613; H01M 10/6556; H01M 10/6568; H01M 2220/20

(57) ABSTRACT

Thermal mitigation techniques are provided that utilize coolant for mitigating or suppressing battery thermal events within traction battery packs. An exemplary battery array of a traction battery pack may include a heat exchanger plate having one or more holes sealed by a plug. The plugs may release coolant into a gas-tight chamber of the battery array during a battery thermal event. The coolant may flood the gas-tight compartment or may be directed as a pressurized coolant spray into the gas-tight compartment to mitigate the battery thermal event.

### TECHNICAL FIELD

This disclosure relates generally to traction battery packs, and more particularly to thermal mitigation techniques that utilize coolant to mitigate or suppress battery thermal events within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, a battery cell bank disposed within a gas-tight compartment established between a first thermal barrier plate and a second thermal barrier plate, a heat exchanger plate positioned adjacent to the battery cell bank and including an internal coolant circuit for circulating a coolant, a hole formed through a surface of the heat exchanger plate and positioned in fluid communication with the internal coolant circuit, and a plug positioned to seal the hole. The plug is configured to release the coolant into the gas-tight compartment when a temperature within the gas-tight compartment exceeds a predefined temperature threshold of the plug.

In a further non-limiting embodiment of the foregoing battery array, the plug is comprised of a thermally sensitive material.

In a further non-limiting embodiment of either of the foregoing battery arrays, the battery cell bank is part of a cell stack that includes a plurality of compartmentalized battery cell banks.

In a further non-limiting embodiment of any of the foregoing battery arrays, a second cell bank is disposed in a second gas-tight compartment that is separated from the gas-tight compartment by the first thermal barrier plate or the second thermal barrier plate.

In a further non-limiting embodiment of any of the foregoing battery arrays, the first thermal barrier plate and the second thermal barrier plate each include a mica material or an aerogel material.

In a further non-limiting embodiment of any of the foregoing battery arrays, the heat exchanger plate is positioned above the battery cell bank such that the coolant is gravity fed into the gas-tight compartment when the temperature exceeds the predefined temperature threshold.

In a further non-limiting embodiment of any of the foregoing battery arrays, the heat exchanger plate is positioned below the battery cell bank such that the coolant floods the gas-tight compartment when the temperature exceeds the predefined temperature threshold.

In a further non-limiting embodiment of any of the foregoing battery arrays, a pump is configured to pump the coolant through the internal coolant circuit.

In a further non-limiting embodiment of any of the foregoing battery arrays, the heat exchanger plate is positioned below the battery cell bank. A second heat exchanger plate is positioned above the battery cell bank.

In a further non-limiting embodiment of any of the foregoing battery arrays, the second heat exchanger plate includes a second hole formed through a surface of the second heat exchanger plate and positioned in fluid communication with a second internal coolant circuit of the second heat exchange plate, and a second plug is positioned to seal the second hole. The second plug is configured to release the coolant into the gas-tight compartment when the temperature exceeds the predefined temperature threshold.

In a further non-limiting embodiment of any of the foregoing battery arrays, the hole is sized and shaped to spray the coolant into the gas-tight compartment when the temperature exceeds the predefined temperature threshold.

In a further non-limiting embodiment of any of the foregoing battery arrays, the coolant within the internal coolant circuit is configured to boil when the temperature exceeds the predefined temperature threshold.

In a further non-limiting embodiment of any of the foregoing battery arrays, a coolant hose is connected to an inlet or an outlet of the heat exchanger plate.

In a further non-limiting embodiment of any of the foregoing battery arrays, the coolant hose includes a second hole and a second plug positioned to seal the second hole. The second plug is configured to release the coolant into an open area around the battery array when a temperature near the battery array exceeds a predefined temperature threshold of the second plug.

In a further non-limiting embodiment of any of the foregoing battery arrays, the first thermal barrier plate and the second thermal barrier plate are secured to an array support structure that surrounds a cell stack that includes the battery cell bank.

A battery array for a traction battery pack according to another exemplary aspect of the present disclosure includes, among other things, a cell stack including a battery cell bank disposed within a gas-tight compartment established between a first thermal barrier plate and a second thermal barrier plate, a heat exchanger plate positioned adjacent to the cell stack and including an internal coolant circuit for circulating a coolant, and a hole formed through a surface of the heat exchanger plate and in fluid communication with the internal coolant circuit. The hole is configured to spray the coolant into the gas-tight compartment as a pressured coolant spray when a temperature within the gas-tight compartment exceeds a predefined temperature threshold.

In a further non-limiting embodiment of the foregoing battery array, the battery cell bank includes a plurality of battery cells.

In a further non-limiting embodiment of either of the foregoing battery arrays, a plug is positioned to seal the hole. The plug is configured to release the coolant into the gas-tight compartment when the temperature exceeds the predefined temperature threshold.

In a further non-limiting embodiment of any of the foregoing battery arrays, the coolant within the internal coolant circuit is configured to boil to create the pressurized coolant spray when the temperature exceeds the predefined temperature threshold.

In a further non-limiting embodiment of any of the foregoing battery arrays, a coolant hose is connected to an inlet or an outlet of the heat exchanger plate. The coolant hose is configured to spray the coolant into an open area adjacent the battery array when a temperature near the battery array exceeds a predefined temperature threshold.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 is a cross-sectional view through section 3-3 of the battery array of FIG. 2.

FIG. 4 illustrates another exemplary battery array for a traction battery pack.

FIG. 5 illustrates another exemplary battery array for a traction battery pack.

FIG. 6 illustrates another exemplary battery array for a traction battery pack.

FIG. 7 is a cross-sectional view through section 7-7 of the battery array of FIG. 6.

FIG. 8 illustrates another exemplary battery array for a traction battery pack.

FIG. 9 is a cross-sectional view through section 9-9 of the battery array of FIG. 8.

### DETAILED DESCRIPTION

This disclosure details various thermal mitigation techniques that utilize coolant for mitigating or suppressing battery thermal events within traction battery packs. An exemplary battery array of a traction battery pack may include a heat exchanger plate having one or more holes sealed by a plug. The plugs may release coolant into a gas-tight chamber of the battery array during a battery thermal event. The coolant may flood the gas-tight compartment or may be directed as a pressurized coolant spray into the gas-tight compartment to mitigate the battery thermal event. These and other features are discussed in greater detail in the following paragraphs of this detailed description.

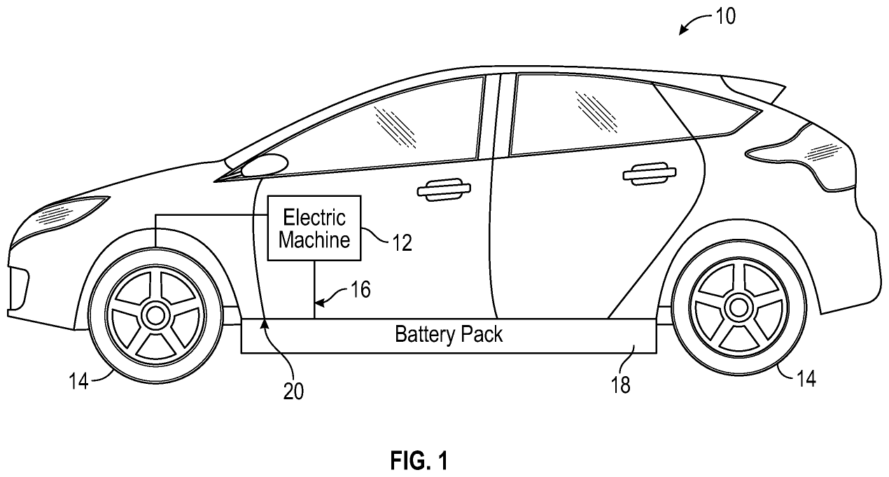

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 may be a full electric vehicle propelled solely through electric power, such as by one or more electric machines 12, without any assistance from an internal combustion engine, although the teachings of this disclosure are also applicable to vehicles that include internal combustion engines. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

From time to time, one or more battery cells of the traction battery pack 18 can experience a battery thermal event in which pressure and thermal energy of the one or more battery cells increases. The pressure and thermal energy increases can be due to an overcharge condition, an overdischarging condition, or a short circuit event, for example. The pressure and thermal energy increases can cause the battery cell experiencing the thermal event to release gas and/or other effluents. The gases/effluents may be released as a result of an applied force or a thermal event, and can either cause or exacerbate an existing battery thermal event. A relatively significant amount of heat can be generated during battery thermal events, and this heat can sometimes cascade from cell-to-cell and/or array-to-array within the traction battery pack 18. As further discussed below, the traction battery pack 18 may therefore be equipped with features for mitigating the effects of battery thermal events.

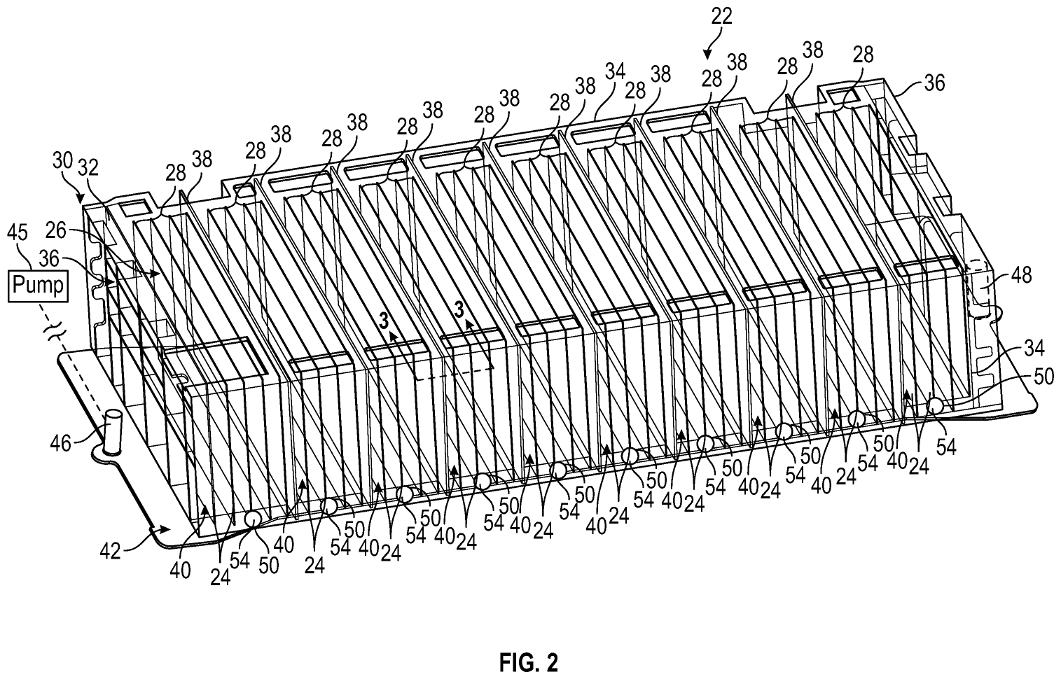

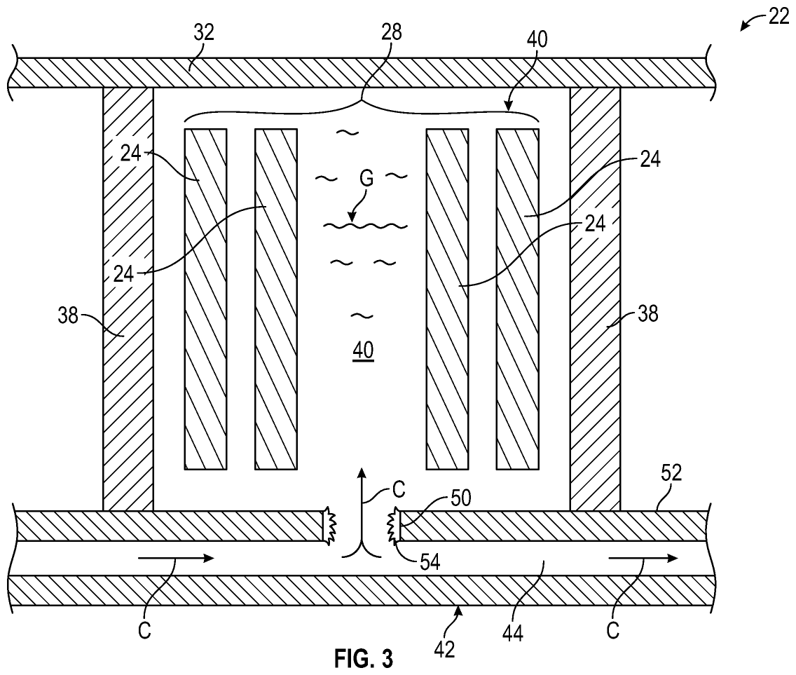

FIGS. 2 and 3 illustrate an exemplary battery array 22 for a traction battery pack, such as the traction battery pack 18 of FIG. 1, for example. One or more battery arrays having the design of the battery array 22 shown in FIG. 2 could be packaged within the traction battery pack 18. As explained in further detail below, the battery array 22 may incorporate features designed for mitigating or even suppressing battery thermal events.

The battery array 22 may include a plurality of battery cells 24. In an embodiment, the battery cells 24 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

The battery cells 24 may be grouped together in a cell stack 26, which itself may include two or more cell banks 28. In the illustrated embodiment, the cell stack 26 includes ten cell banks 28, and each cell bank 28 includes a total of four battery cells 24. However, each cell bank 28, and thus the cell stack 26, could include any number of battery cells within the scope of this disclosure. The cells banks 28 may be electrically connected to one another to provide either a series string configuration or a parallel string configuration.

An array support structure 30 may be arranged to substantially surround the cell stack 26. In an embodiment, the array support structure 30 completely encloses the cell stack 26. The array support structure 30 may include a top plate 32, a pair of side plates 34, and a pair of end plates 36.

The cell stack 26 may additionally include a plurality of thermal barrier plates 38. The thermal barrier plates 38 may be positioned at various spaced-apart locations along the length of the cell stack 26. The thermal barrier plates 38 may separate the cell banks 28 from one another. In an embodiment, each cell bank 28 is located between an adjacent pair of thermal barrier plates 38, and therefore the cell banks 28 are compartmentalized within the battery array 22. However, other configurations are also contemplated, and therefore the total number and positioning of the thermal barrier plates 38 provided as part of the cell stack 26 is not intended to limit this disclosure.

The thermal barrier plates 38 may be single or multi-layered plate-like structures. In an embodiment, each thermal barrier plate 38 may be constructed from one or more thermal barrier materials. Exemplary thermal barrier materials include but are not limited to mica, aerogel, refractory ceramic fibers, etc. However, the thermal barrier plates 38 could be constructed from other thermal barrier materials or combinations of thermal barrier materials within the scope of this disclosure.

Each thermal barrier plate 38 may be mounted to portions of the array support structure 30. In an embodiment, each thermal barrier plate 38 is mounted (e.g., glued or otherwise secured) to the top plate 32 and each of the side plates 34 of the array support structure 30.

A gas-tight compartment 40 may extend between each adjacent pair of thermal barrier plates 38. Therefore, each cell bank 28 may be located within one of the gas-tight compartments 40. The battery cells 24 of each cell bank 28 may be arranged to vent gases G (see FIG. 3) and other effluents into their respective gas-tight compartment 40 during a battery thermal event. The gas-tight compartments 40 may therefore be configured to isolate the vent gases G during battery thermal events.

The cell stack 26 may be arranged to interface with a heat exchanger plate 42 (e.g., a liquid cooled cold plate). The array support structure 30 of the battery array 22 may be secured to the heat exchanger plate 42 using any suitable fastening technique. The heat exchanger plate 42 may be part of a thermal management system configured for thermally managing the battery cells 24 of the battery array 22. An internal coolant circuit 44 (best shown in FIG. 3) may be provided inside the heat exchanger plate 42 for circulating a coolant C.

The coolant C may be circulated through the internal coolant circuit 44 to thermally condition the battery cells 24 of the battery array 22. The coolant C may enter the internal coolant circuit 44 through an inlet 46 of the heat exchanger plate 42 and may exit from the internal coolant circuit 44 through an outlet 48 of the heat exchanger plate 42. The inlet 46 and the outlet 48 may be in fluid communication with a coolant source (not shown), which could be part of a main cooling system of the electrified vehicle 10 or could be a dedicated coolant source of the traction battery pack 18. Although not shown, the coolant C may pass through a heat exchanger subsequent to exiting the outlet 48 but before entering the inlet 46 of the heat exchanger plate 42. A pump 45 may circulate the coolant C through the internal coolant circuit 44.

In use, heat released by the battery cells 24 may be conducted into the heat exchanger plate 42 and then into the coolant C as the coolant C is communicated through the internal coolant circuit 44. The heat may therefore be carried away from the battery cells 24 by the coolant C.

In an embodiment, the coolant C is a conventional type of coolant mixture, such as water mixed with ethylene glycol. However, other coolants, including gases, are also contemplated within the scope of this disclosure.

The heat exchanger plate 42 may additionally be configured to mitigate battery thermal events that originate from within the battery array 22. For example, a plurality of holes 50 may be formed in a surface 52 of the heat exchanger plate 42 that faces toward the cell stack 26. Each hole 50 may be in fluid communication with the internal coolant circuit 44 of the heat exchanger plate 42.

The holes 50 may be arranged such that at least one of the holes 50 is provided for each gas-tight compartment 40. However, other configurations are also contemplated within the scope of this disclosure. Additionally, each hole 50 may be sealed off by a plug 54. The plug 54 may be made of a thermally sensitive material, including but not limited to thermal wax elements or other thermal actuators, for example.

During normal operating conditions of the battery array 22, the holes 50 of the heat exchanger plate 42 remain sealed by the plugs 54, and therefore the coolant C is prevented from entering the gas-tight compartments 40 (see FIG. 2). However, when the temperature within one or more of the gas-tight compartments 40 exceeds a predefined temperature threshold (e.g., about 200 degrees C.) in response to a battery thermal event occurring within the respective one or more gas-tight compartments 40, the plug 54 of the hole(s) 50 may melt, rupture, or otherwise open. The coolant C may then escape through the hole 50 and flood the gas-tight compartment 40 where the battery thermal event is occurring (see FIG. 3), thereby slowing or even stopping cell-to-cell and/or cell bank-to-cell bank thermal propagation. The pump 45 may be operational during the battery thermal event in order to effectively push the coolant C into the gas-tight compartment 40 at the onset of the battery thermal event. In this disclosure, the term “about” means that the expressed quantities or ranges need not be exact but may be approximated and/or larger or smaller, reflecting acceptable tolerances, conversion factors, measurement error, etc.

In the illustrated embodiment, the heat exchanger plate 42 establishes a bottom section of the array support structure 30. Therefore, the gas-tight compartments 40 may be flooded with the coolant C from the bottom of the battery array 22. However, other implementations are possible.

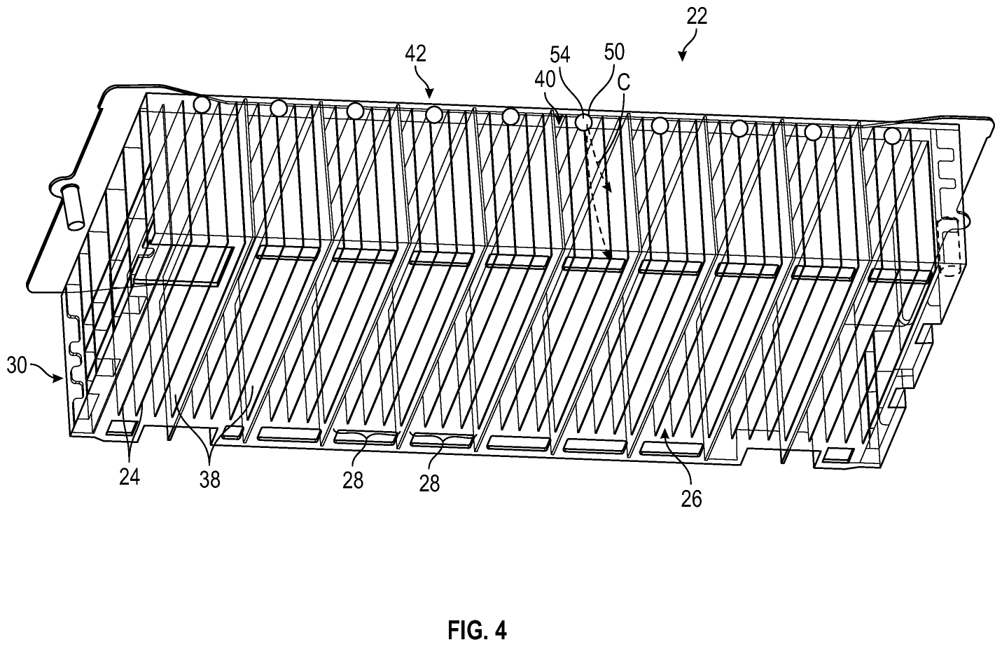

For example, as shown in FIG. 4, the heat exchanger plate 42 could be incorporated as the top plate of the array support structure 30. In such an implementation, the coolant C may be gravity fed into the gas-tight compartments 40 during battery thermal events.

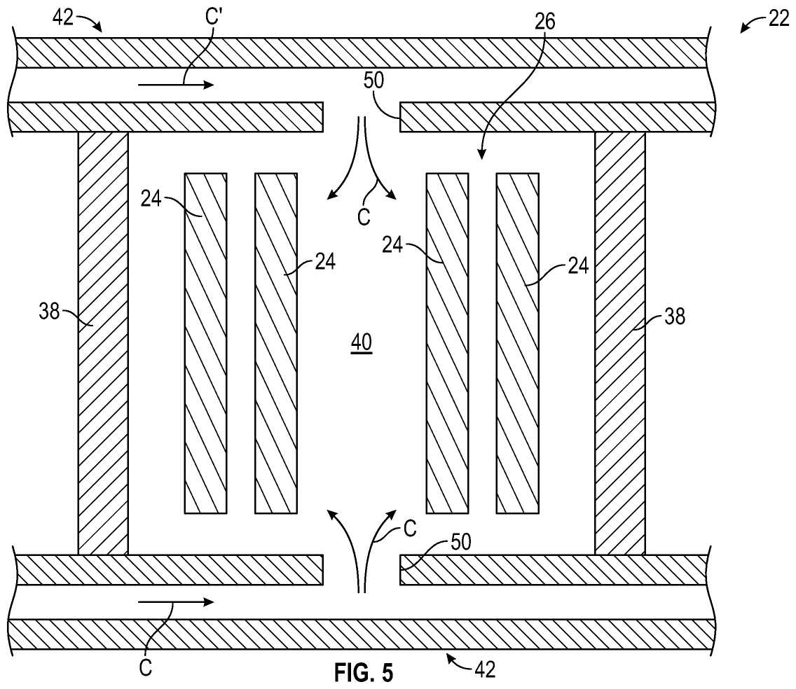

In yet another embodiment, shown in FIG. 5, one heat exchanger plate 42 may be positioned both above and below the cell stack 26. In such an implementation, the coolant C may flood the gas-tight compartments 40 from both the top and the bottom of the battery array 22 during battery thermal events.

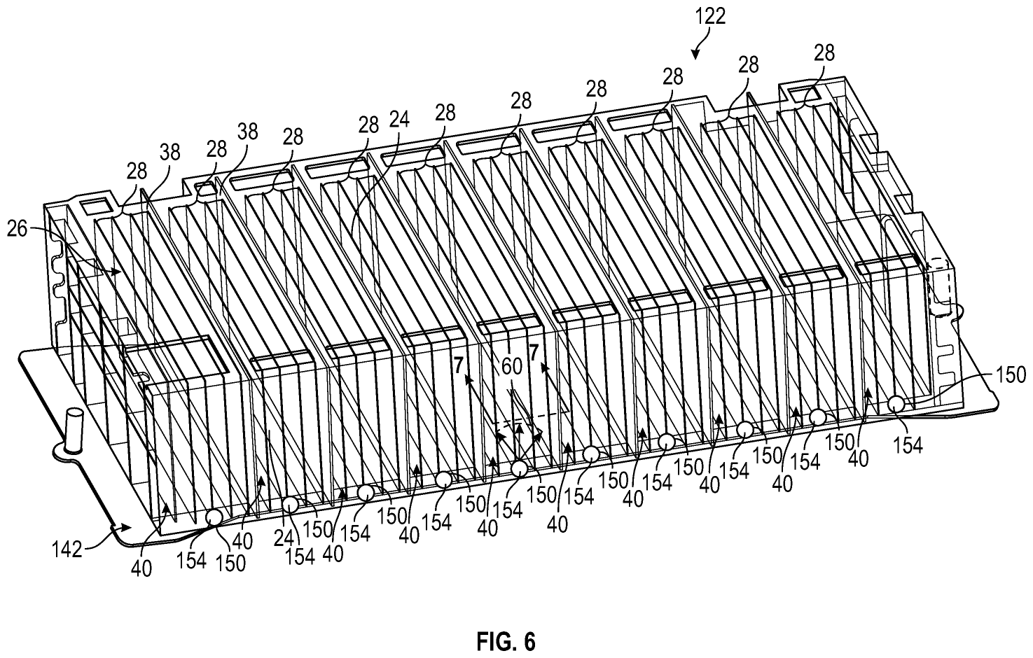

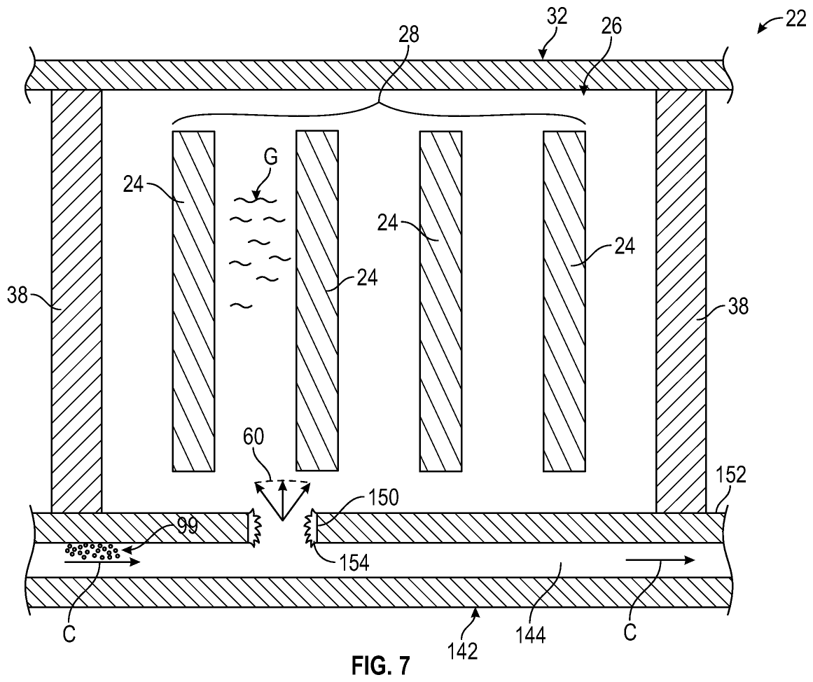

FIGS. 6 and 7 illustrate another exemplary battery array 122 for a traction battery pack, such as the traction battery pack 18 of FIG. 1, for example. The battery array 122 is similar to the battery array 22 discussed above. However, instead of flooding the gas-tight compartments 40 with the coolant C, the battery array 22 may be configured to spray the coolant C to more effectively distribute the coolant C inside the gas-tight compartments 40 during battery thermal events.

Each gas-tight compartment 40 may extend between an adjacent pair of thermal barrier plates 38. Therefore, each cell bank 28 may be located within one of the gas-tight compartments 40, and the battery cells 24 of each cell bank 28 may be arranged to vent gases G (see FIG. 7) and other effluents into their respective gas-tight compartment 40 during a battery thermal event.

The cell stack 26 of the battery array 122 may be arranged to interface with a heat exchanger plate 142. A plurality of holes 150 may be formed in a surface 152 of the heat exchanger plate 142 that faces toward the cell stack 26 of the battery array 122. Each hole 150 may be in fluid communication with an internal coolant circuit 144 of the heat exchanger plate 142. The holes 150 may be arranged such that at least one of the holes 150 is provided for each gas-tight compartment 40 of the battery array 122.

Each hole 150 may be sized and shaped for directing a pressurized coolant spray 60 into one or more of the gas-tight compartments 40 during battery thermal events. The holes 150 may therefore act as nozzles for effectively distributing the coolant C within the gas-tight compartment 40 where the battery thermal event is occurring. The relatively high temperatures created during the battery thermal event may cause the coolant C inside the internal coolant circuit 144 of the heat exchanger plate 142 to boil (schematically illustrated at reference numeral 99 in FIG. 7), thereby increasing its pressure and velocity. The increased pressure and velocity of the coolant C may force the coolant C through the hole(s) 150 as the pressurized coolant spray 60.

Each hole 150 may be sealed off by a plug 154. The plug 154 may be made of a thermally sensitive material.

During normal operating conditions of the battery array 122, the holes 150 of the heat exchanger plate 142 remain sealed by the plugs 154, and therefore the coolant C is prevented from entering the gas-tight compartments 40 (see FIG. 6). However, when the temperature within one or more of the gas-tight compartments 40 exceeds a predefined temperature threshold (e.g., about 200 degrees C.) in response to a battery thermal event occurring within the respective one or more gas-tight compartments 40, the plug 154 of the hole(s) 50 may melt, rupture, or otherwise open. The hole 150 may then inject the pressurized coolant spray 60 into the gas-tight compartment 40 where the battery thermal event is occurring (see FIG. 7), thereby slowing or even stopping cell-to-cell and/or cell bank-to-cell bank thermal propagation.

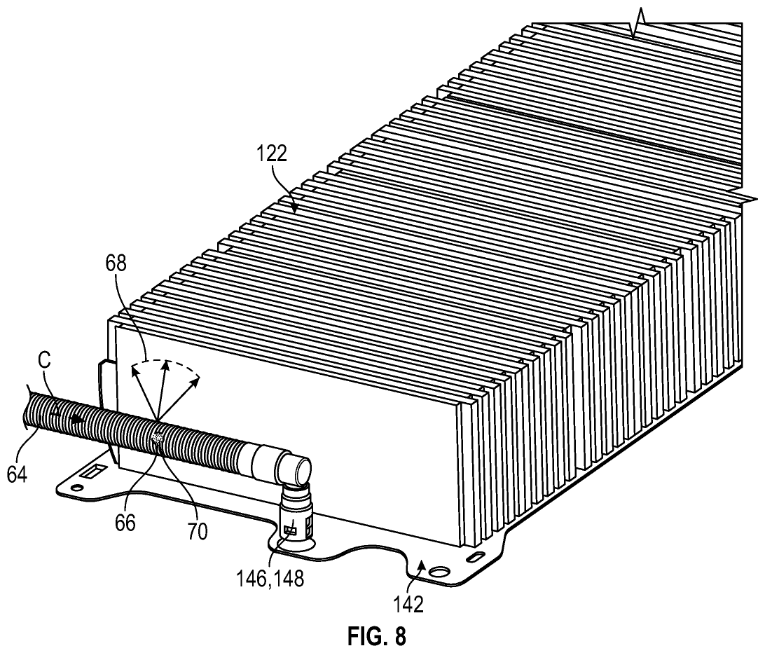

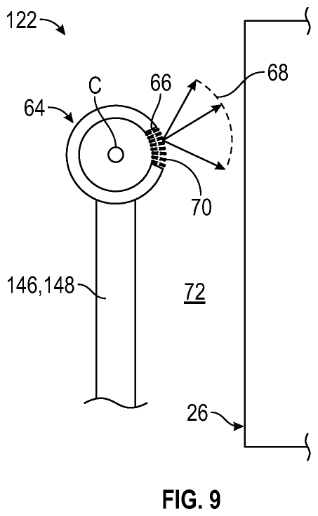

Referring now to FIGS. 8 and 9 (with continued reference to FIGS. 7-8), a coolant hose 64 may be connected to an inlet 146 and/or an outlet 148 of the heat exchanger plate 142. The coolant hose 64 may carry coolant C to/from the internal coolant circuit 144 of the heat exchanger plate 142.

Each coolant hose 64 may optionally include one or more holes 66. The Each hole 66 may be sized and shaped for directing a pressurized coolant spray 68 (see FIG. 9) within one or more open spaces 72 that are located outside the battery array 122 during battery thermal events. The hole 66 may therefore act as a nozzle for effectively distributing the coolant C about external portions of the battery array 122 when a battery thermal event is occurring. The relatively high temperatures created during the battery thermal event may cause the coolant C inside the coolant hose 64 to boil, thereby increasing its pressure and velocity. The increased pressure and velocity of the coolant C may force the coolant C through the hole 66 as the pressurized coolant spray 68.

The hole 66 may be sealed off by a plug 70 during normal operating conditions of the battery array 122. The plug 70 may be made of a thermally sensitive material. The plug 70 may melt, rupture, or otherwise open when a temperature near the coolant hose 64 exceeds a predefined temperature threshold, thereby allowing the coolant C to be injected through the hole 66 as the pressurized coolant spray 68.

The coolant hose 64 with the hole(s) 66 may be provided either alone or in combination with the holes 150 of the heat exchanger plate 142. The proposed designs may therefore mitigate battery thermal events from inside the battery array 122, outside the battery array 122, or both.

The exemplary battery designs of this disclosure are capable of rapidly mitigating or suppressing battery thermal events using coolant. The proposed designs utilize equipment and coolant already present in most traction battery designs and therefore are simple to implement yet effective at limiting the effects of battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
a battery cell bank disposed within a gas-tight compartment established between a first thermal barrier plate and a second thermal barrier plate;
a heat exchanger plate positioned adjacent to the battery cell bank and including an internal coolant circuit for circulating a coolant;
a hole formed through a surface of the heat exchanger plate and positioned in fluid communication with the internal coolant circuit; and
a plug positioned to seal the hole,
wherein the plug is configured to release the coolant into the gas-tight compartment when a temperature within the gas-tight compartment exceeds a predefined temperature threshold of the plug.

2. The battery array as recited in claim 1, wherein the plug is comprised of a thermally sensitive material.

3. The battery array as recited in claim 1, wherein the battery cell bank is part of a cell stack that includes a plurality of compartmentalized battery cell banks.

4. The battery array as recited in claim 1, comprising a second cell bank disposed in a second gas-tight compartment that is separated from the gas-tight compartment by the first thermal barrier plate or the second thermal barrier plate.

5. The battery array as recited in claim 1, wherein the first thermal barrier plate and the second thermal barrier plate each include a mica material or an aerogel material.

6. The battery array as recited in claim 1, wherein the heat exchanger plate is positioned above the battery cell bank such that the coolant is gravity fed into the gas- tight compartment when the temperature exceeds the predefined temperature threshold.

7. The battery array as recited in claim 1, wherein the heat exchanger plate is positioned below the battery cell bank such that the coolant floods the gas-tight compartment when the temperature exceeds the predefined temperature threshold.

8. The battery array as recited in claim 7, comprising a pump configured to pump the coolant through the internal coolant circuit.

9. The battery array as recited in claim 1, wherein the heat exchanger plate is positioned below the battery cell bank, and further comprising a second heat exchanger plate positioned above the battery cell bank.

10. The battery array as recited in claim 9, wherein the second heat exchanger plate includes:
a second hole formed through a surface of the second heat exchanger plate and positioned in fluid communication with a second internal coolant circuit of the second heat exchange plate; and
a second plug positioned to seal the second hole,
wherein the second plug is configured to release the coolant into the gas-tight compartment when the temperature exceeds the predefined temperature threshold.

11. The battery array as recited in claim 1, wherein the hole is sized and shaped to spray the coolant into the gas-tight compartment when the temperature exceeds the predefined temperature threshold.

12. The battery array as recited in claim 11, wherein the coolant within the internal coolant circuit is configured to boil when the temperature exceeds the predefined temperature threshold.

13. The battery array as recited in claim 1, comprising a coolant hose connected to an inlet or an outlet of the heat exchanger plate.

14. The battery array as recited in claim 13, wherein the coolant hose includes a second hole and a second plug positioned to seal the second hole, wherein the second plug is configured to release the coolant into an open area around the battery array when a temperature near the battery array exceeds a predefined temperature threshold of the second plug.

15. The battery array system as recited in claim 1, wherein the first thermal barrier plate and the second thermal barrier plate are secured to an array support structure that surrounds a cell stack comprising the battery cell bank.

16. A battery array for a traction battery pack, comprising:
a cell stack including a battery cell bank disposed within a gas-tight compartment established between a first thermal barrier plate and a second thermal barrier plate;
a heat exchanger plate positioned adjacent to the cell stack and including an internal coolant circuit for circulating a coolant; and
a hole formed through a surface of the heat exchanger plate and in fluid communication with the internal coolant circuit,
wherein the hole is configured to spray the coolant into the gas-tight compartment as a pressured coolant spray when a temperature within the gas-tight compartment exceeds a predefined temperature threshold.

17. The battery array as recited in claim 16, wherein the battery cell bank includes a plurality of battery cells.

18. The battery array as recited in claim 16, comprising a plug positioned to seal the hole, wherein the plug is configured to release the coolant into the gas-tight compartment when the temperature exceeds the predefined temperature threshold.

19. The battery array as recited in claim 16, wherein the coolant within the internal coolant circuit is configured to boil to create the pressurized coolant spray when the temperature exceeds the predefined temperature threshold.

20. The battery array as recited in claim 16, comprising a coolant hose connected to an inlet or an outlet of the heat exchanger plate, wherein the coolant hose is configured to spray the coolant into an open area adjacent the battery array when a temperature near the battery array exceeds a predefined temperature threshold.
